(19) United States
(12) Patent Application Publication
(10) Pub. No.: US 2021/0249160 A1
(43) Pub. Date: Aug. 12, 2021

(54) WIRE HAVING A HOLLOW MICRO-TUBING AND METHOD THEREFOR

(71) Applicant: Jonathan Jan, Culver CIty, CA (US)

(72) Inventor: Jonathan Jan, Culver CIty, CA (US)

(21) Appl. No.: 17/146,148

(22) Filed: Jan. 11, 2021

Related U.S. Application Data
(60) Provisional application No. 62/975,314, filed on Feb. 12, 2020.

(51) Int. Cl. H01B 13/00; H01B 1/04; H01B 5/06

(52) U.S. Cl. CPC H01B 13/0036; H01F 5/06; H01B 5/06; H01B 1/04

(57) ABSTRACT

A method of forming a metallic wire comprises obtaining a core conductor and wrapping the core conductor with a cladding material forming a cladded wire.

### RELATED APPLICATIONS

This patent application is related to U.S. Provisional Application No. 62/975,314 filed Feb. 12, 2020, entitled “HOLLOW MICRO-TUBING AND METHOD THEREFOR” in the name of Jonathan Jan, and which is incorporated herein by reference in its entirety. The present patent application claims the benefit under 35 U.S.C § 119(e).

### TECHNICAL FIELD

The present application generally relates to wiring, and more specifically, to a method of forming a hollow metal wire for use in electromagnetic devices.

### BACKGROUND

Electromagnetic devices such as transformers, electric motors, induction coils and similar devices may be formed with wound magnet wires. The magnet wires may be wrapped around a bar of iron or other ferromagnetic material. When the electric current flows through the magnet wire, it causes the bar of ferromagnetic material to become magnetized. In general, most electromagnetic devices may use magnet wires drawn from copper alloys or copper-clad aluminum wire.

In use, many electromagnetic devices may become warm. This is generally considered to be normal since wherever there is electricity generated, there is also heat. Electricity may be the result of subatomic particles, electrons and protons, that may be charged either positively (protons) or negatively (electrons) and interact with each other. The interaction of protons and electrons creates electromagnetic charge or electrical current, that moves, which may create the heat.

A common cause of failure in many electromagnetic devices may be overheating. Excessive heat buildup may burn the insulation around the magnet wires leading to a short circuit. One solution to this problem is using stranded small wires instead of one solid core large diameter wire. Since free electrons flow along the surface of the wire, less resistance from orbital electrons may be present. While using stranded small wires instead of one solid core large diameter wire does work, it may be desirable to increase the surface area of the wires for passage of the electromagnetic energy.

Unlike DC current, AC electricity passes through a wire in the form of electromagnetic waves along the peripheral of the wire's surface. Therefore, a hollow wire would have twice the surface area for passage of the electromagnetic wave, while reducing the orbital electron's internal resistance due to reduced cross-section of the wire. Further, less material is used for the hollow wire. In general, magnet wires have diameters that may range from 10 microns to several millimeters. However, traditional tube drawing processes is impractical for making such small diameter hollow wires (tubing).

Therefore, it would be desirable to provide a system and method that overcomes the above.

### SUMMARY

In accordance with one embodiment, a method of forming a metallic wire is disclosed. The method comprises obtaining a core conductor and wrapping the core conductor with a cladding material forming a cladded wire.

In accordance with one embodiment, a method of forming a metallic wire having a hollow interior core is disclosed. The method comprises: obtaining a core formed of a material having a core melting point temperature; wrapping a cladding material around the core forming a cladded wire, wherein the cladding material has a cladding melting point temperature higher than the core melting point temperature; heating the cladded wire at a temperature greater than core melting point temperature; and removing the material forming the core that has melted forming the metallic wire having the hollow interior core.

In accordance with one embodiment, a method of forming a metallic wire having a hollow interior core is disclosed. The method comprises: obtaining a core formed of lead-tin or other tin alloys having a core melting temperature between 50° C. and 250° C.; wrapping a cladding material around the core forming a cladded wire, wherein the cladding material is copper or a copper-nickel alloy having a cladding melting point temperature equal to or greater than 1060° C.; heating a chamber of a die having a desired diameter to a temperature above the core melting point temperature but less than the cladding melting point temperature to melt the core; drawing the cladded wire through the die smoothing and annealing the cladding material; and removing the material forming the core that has melted forming the metallic wire having the hollow interior core.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a cross-sectional front view of a core used in forming an exemplary embodiment of a metal wire having a hollow interior in accordance with an embodiment of the present invention;

FIG. 2 is a cross-sectional front view of a metal clad wire used in forming an exemplary embodiment of a metal wire having a hollow interior in accordance with an embodiment of the present invention;

FIG. 3 is a cross-sectional front view of an exemplary embodiment of a metal wire having a hollow interior in accordance with an embodiment of the present invention;

FIG. 4 is a perspective view of an exemplary embodiment of a metal wire having a hollow interior in accordance with an embodiment of the present invention;

FIG. 5 is a flowchart showing an exemplary method of forming a metal wire having a hollow interior in accordance with an embodiment of the present invention; and

FIG. 6 is a cross-sectional front view of an exemplary embodiment of a metal wire in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a metal wire which utilizes cladding methodologies where a low melting temperature wire is used as a sacrificial core for making the metal wire having a hollow interior. The method will allow the formation of metal wires having a hollow interior for metal wires having diameters of 10 microns to several millimeters in size.

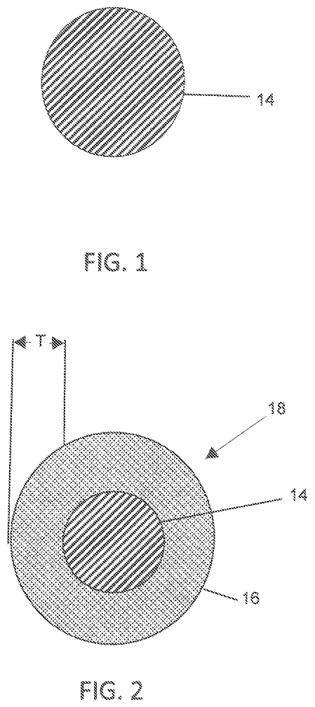

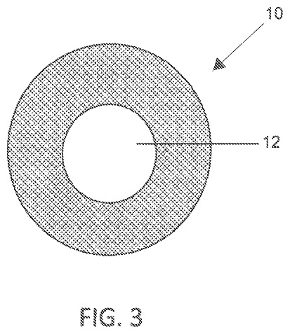

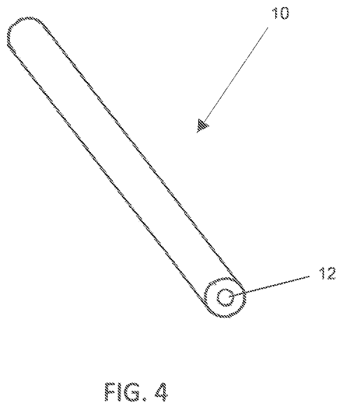

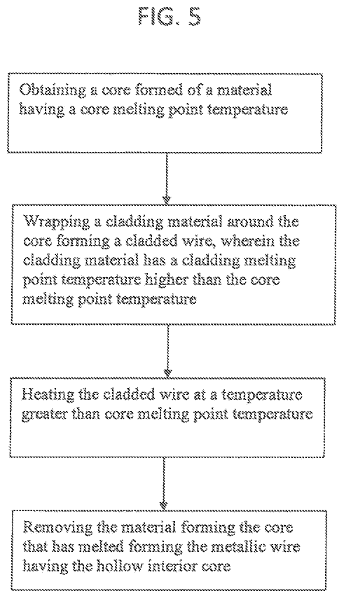

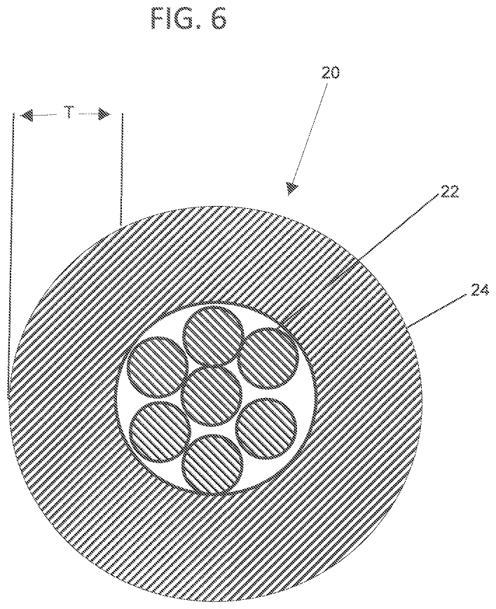

Referring to the FIGs., a metal wire 10 may be formed having a hollow interior 12. The metal wire 10 may be formed utilizing cladding methodologies where a low melting temperature wire may be used as a sacrificial core 14 for forming the hollow interior 12. As may be seen in FIG. 1, a cross-sectional view of the core 14 may be seen. In accordance with one embodiment, the core 14 may be formed of a material having a melting point of 150° C. to 250° C. or more. In accordance with one embodiment, the core 14 may be formed of a lead-tin or other tin alloy with melting temperature between 150° C. to 250° C.

The diameter of the core 14 and the material of the core 14 may be based on a desired usage of the metal wire 10. In accordance with one embodiment, the core 14 may be a lead-tin metal core having a diameter of approximately 4 mm.

As may be seen in FIG. 2, the core 14 may be wrapped with a cladding material 16 to formed a clad wire 18. The cladding material 16 may be of a material having a higher melting temperature than the core 14. In accordance with one embodiment, the cladding material 16 may be copper or a copper-nickel alloys. Copper may have a melting point of around 1084° C., while copper-nickel alloys may have a melting point around 1060-1240° C.

The cladding material 16 may be continually wrapped around the core 14 to form a desired thickness T. In accordance with one embodiment, the cladding material 16 may be wrapped around the core 14 to a thickness of 3 mm. If the core 14 is approximately 4 mm, the total thickness of the wire 10 may be around 10 mm.

The clad wire 18 may then be drawn through a die having a desired diameter in a chamber which is heated. The chamber may be heated and held at the melting temperature of the material of the core 14. This process may smooth out the surfaces of the cladding material 16, while strengthening and anneals the cladding material 16. The heating of the chamber may cause the material of the core 14 to melt. A vacuum may then be applied to one of the ends clad wire 18 so that the core material may be vacated and recovered for future use and forming the metal wire 10 having the hollow interior 12. Depending on the die, the finished metal wire 10 can have an outer diameter anywhere between 0.1 mm and 8 mm in size. The metal wire 10 may then be cooled after being run through the chamber of the die.

The metal wire 10 has several unique benefits over a solid wire used in electromagnetic devices. First, since the metal wire 10 has a hollow interior 12, this reduce the amount of conducting metal for the same diameter of magnet wire. In accordance with one embodiment, the reduction may be over 50%. Second, the metal wire 10 may increase the A/C electricity passing through a same diameter solid magnet wire. As stated above, AC electricity passes through a wire in the form of electromagnetic waves along the peripheral of the wire's surface. Thus, the hollow interior 12 would have twice the surface area for passage of the electromagnetic wave. Third, the increase in surface area of the electromagnetic wave may reduce the orbital electron's internal resistance due to the reduced cross-section of the wire. Thus, the metal wire 10 may substantially decrease the amount of electricity and heat in generated in certain applications.

It should be noted that other materials than those mentioned above may be used based on the application. For example, in one other application pyrolytic carbon fiber may be used as the material of the core. Pyrolytic carbon is a magnetic superconductor as well as thermal superconductor. The metal wire formed using pyrolytic carbon fiber may have tremendous advantages in mission-critical applications.

Referring to FIG. 6, another exemplary embodiment of a wire 20 may be seen. In this embodiment, the wire 20 has a core 22. The core 22 may be a single strand core or a multi-strand core. In the embodiment shown, the core 22 is a multi-strand core having seven (7) strands. However, this is shown as an example and should not be seen in a limiting manner.

The core 22 may be formed of carbon fiber. Carbon fiber has many advantages over traditional metal conductors. Carbon fiber is a magnetic superconductor as well as thermal superconductor. Carbon fiber has high stiffness and strength, is lightweight, corrosion resistance, X-ray transparency, has a low Coefficient of Thermal Expansion (CTE), is chemical resistivity and has high thermal and electrical conductivity.

The core 22 may be may be wrapped with a cladding material 24 to formed a clad wire 26. In accordance with one embodiment, the cladding material 24 may be copper or a copper-nickel alloys. The cladding material 24 may be continually wrapped around the core 22 to form a desired thickness T. In accordance with one embodiment, the cladding material 24 may be wrapped around the core 22 to a thickness of 3 mm. If the core 22 is approximately 4 mm, the total thickness of the wire 20 may be around 10 mm. The dual material wire 20 has improved electromagnetic and thermodynamic characteristics over prior art wires. It should be noted that the wire 20 may be heated depending on whether polymer binding material is desired. For example, magnetic wires may need an insulating film covering the magnetic wire.

The foregoing description is illustrative of particular embodiments of the application, but is not meant to be a limitation upon the practice thereof. The following claims, including all equivalents thereof, are intended to define the scope of the application.

What is claimed is:

1. A method of forming a metallic wire comprising:
obtaining a core conductor; and
wrapping the core conductor with a cladding material forming a cladded wire.

2. The method of claim 1, wherein the core conductor is a carbon fiber core conductor.

3. The method of claim 2, wherein the carbon fiber core conductor is a multi-strand carbon fiber core conductor.

4. The method of claim 1, comprising:
obtaining the core conductor formed of a core material having a core melting point temperature lower than a cladding melting point temperature of the cladding material; and
heating the cladded wire at a temperature greater than the core melting point temperature.

5. The method of claim 4, wherein heating the cladded wire comprises heating the cladded wire at the temperature greater than the core melting point temperature but less than the cladding melting point temperature.

6. The method of claim 4, wherein heating the cladded wire comprises:
heating a chamber of a die having a desired diameter above the core melting point temperature; and
drawing the cladded wire through the die having the desired diameter smoothing and annealing the cladding material.

7. The method of claim 6, comprising vacuuming one end of the cladded wire removing the core conductor that melted.

8. The method of claim 4, wherein the core conductor is formed of lead-tin or other tin alloys.

9. The method of claim 4, wherein the wire conductor is formed of lead-tin or other tin alloys wherein the core melting point temperature is between 150° C. and 250° C.

10. The method of claim 4, wherein the core conductor is approximately 4 centimeters in diameter.

11. The method of claim 4, wherein the cladding material is copper or a copper-nickel alloy.

12. The method of claim 4, wherein the cladding material is copper or a copper-nickel alloy, the cladding melting point temperature equal to or greater than 1060° C.

13. The method of claim 4, wherein the cladding material has a thickness of at least 3 mm.

14. A method of forming a metallic wire having a hollow interior core comprising:
wrapping a core with a cladding material forming a cladded wire, wherein a melting point temperature of a material forming the core is lower than a melting point temperature of the cladding material; and
heating the cladded wire at a temperature greater than the melting point temperature of the material forming the core.

15. The method of claim 14, wherein heating the cladded wire comprises heating the cladded wire at the temperature greater than the melting point of the material forming the core but less than the melting point temperature of the cladding material.

16. The method of claim 14, wherein heating the cladded wire comprises:
heating a chamber of a die having a desired diameter above the melting point temperature of the material forming the core; and
drawing the cladded wire through the die having the desired diameter smoothing and annealing the cladding material.

17. The method of claim 16, comprising vacuuming one end of the cladded wire removing the material forming the core that melted.

18. The method of claim 14, wherein the core is formed of lead-tin or other tin alloys having a melting temperature between 150° C. and 250° C.

19. The method of claim 14, wherein the core is approximately 4 centimeters in diameter.

20. The method of claim 14, wherein the cladding material is copper or a copper-nickel alloy having a melting temperature equal to or greater than 1060° C.

21. The method of claim 14, wherein the cladding has a thickness of at least 3 mm.

22. A method of forming a metallic wire having a hollow interior core comprising:
obtaining a core formed of lead-tin or other tin alloys having a core melting temperature between 150° C. and 250° C.;
wrapping a cladding material around the core forming a cladded wire, wherein the cladding material is copper or a copper-nickel alloy having a cladding melting point temperature equal to or greater than 1060° C.;
heating a chamber of a die having a desired diameter to a temperature above the core melting point temperature but less than the cladding melting point temperature to melt the core;
drawing the cladded wire through the die smoothing and annealing the cladding material; and
removing the material forming the core that has melted forming the metallic wire having the hollow interior core.
